(19) United States
(12) Patent Application Publication
(10) Pub. No.: US 2002/0087463 A1
(43) Pub. Date: Jul. 4, 2002

(54) Method and system for authorizing negotiable instrument encashment

(75) Inventors: Maura A. Fitzgerald, Aurora, CO (US); Earney E. Stoutenburg, Highlands Ranch, CO (US); Dean A. Seifert, Parker, CO (US)

Correspondence Address: Mark E. Stuenkel, Brooks & Kushman P.C., 1000 Town Center, Twenty-Second Floor, Southfield, MI, 48075, US

(73) Assignee: First Data Corporation, Hackensack, NJ (US)

(21) Appl. No.: 09/751,126

(22) Filed: Dec. 28, 2000

(51) Int. Cl. G06F 17/60

(52) U.S. Cl. 705/39

(57) ABSTRACT

A method for processing a negotiable instrument includes entering at least one negotiable instrument identifier into a terminal; transmitting the at least one negotiable instrument identifier from the terminal to a host computer; receiving, at the terminal, a sign from the host computer, wherein the sign indicates an authorization status of the negotiable instrument; and automatically printing a mark on a document using a printer in communication with the terminal, wherein the mark corresponds with the sign so as to indicate the authorization status of the negotiable instrument.

### TECHNICAL FIELD

The present invention relates to automated systems and methods for processing negotiable instruments including money orders, gift certificates and the like.

### BACKGROUND ART

Negotiable instruments issued by or on behalf of a financial services firm are used widely for money transfer transactions. Typically, a customer enters an establishment, such as a grocery store, and requests a negotiable instrument, such as a money order, from an agent of the financial services firm. The agent in turn prepares the negotiable instrument and communicates information regarding the negotiable instrument to the financial services firm, which ensures that the negotiable instrument will be honored at other financial institutions, such as banks, savings and loan, credit unions and the like.

Generally, the financial services firm issues preprinted forms for creating negotiable instruments to the agent. When a customer requests a negotiable instrument, the agent fills in specific information, such as the amount of the negotiable instrument, on one of the preprinted forms. The agent also collects funds corresponding to the amount of the negotiable instrument, as well as a surcharge for creating the negotiable instrument. Next, the customer presents the negotiable instrument to a payee. The payee may then go to a particular encashing institution to cash the negotiable instrument. The financial services firm then reimburses the encashing institution for the funds dispersed by the encashing institution.

One problem with the process described above is that one or more preprinted forms may end up in the hands of a person who intends to commit fraud. Such a person may make out the negotiable instrument in his name, enter an amount and present the negotiable instrument to an encashing institution to receive payment. If the person is able to cash the fraudulent negotiable instrument, the financial services firm will incur a loss.

One method used to combat such a fraudulent scheme includes requiring an encashing institution to request an authorization number from the financial services firm before the encashing institution cashes a negotiable instrument for a customer. An employee of the encashing institution may, for example, request such an authorization number using a dial-up voice response unit (VRU), audio response unit (ARU) or personal computer (PC). The authorization number is then written by hand on the negotiable instrument.

Because the authorization number is written by hand, this method has several shortcominings. First, the method is time-consuming. Second, number transposition may occur, which adversely affects reimbursement of funds to the encashing institution.

### DISCLOSURE OF INVENTION

The present invention addresses the shortcominings of the prior art by providing a method and system for processing a negotiable instrument using a printer to automatically print an authorization mark on the negotiable instrument, or other document.

In accordance with one aspect of the present invention, a method is provided for processing a negotiable instrument. The method includes entering at least one negotiable instrument identifier into a terminal; transmitting the at least one negotiable instrument identifier from the terminal to a host computer; receiving, at the terminal, a sign from the host computer, wherein the sign indicates an authorization status of the negotiable instrument; and automatically printing a mark on a document using a printer in communication with the terminal, wherein the mark corresponds with the sign so as to indicate the authorization status of the negotiable instrument.

In accordance with another aspect of the present invention, a system is provided for processing a negotiable instrument. The system includes a terminal for receiving at least one negotiable instrument identifier, and a host computer in communication with the terminal. The host computer is configured to receive the at least one identifier from the terminal and to determine an authorization status of the negotiable instrument. The host computer is also operative to issue a sign to the terminal that is indicative of the authorization status of the negotiable instrument. The system further includes a printing device in communication with the terminal for automatically printing a mark on a document, wherein the mark corresponds with the sign so as to indicate the authorization status of the negotiable instrument.

Because the method and system utilize a printer to automatically print a mark on a document that is indicative of authorization status, the method and system are more efficient than prior methods and systems. Furthermore, accuracy and reliability are significantly improved by the invention.

These and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a schematic diagram of a system according to the present invention for processing a negotiable instrument;

FIG. 2 is a flow chart illustrating operation of a method according to the present invention for processing a negotiable instrument;

FIG. 3 is an example of a negotiable instrument preprinted form that may be used with the method and system of the present invention; and

FIG. 4 is a detailed flow chart illustrating operation of the method according to the present invention for processing the negotiable instrument.

### BEST MODE FOR CARRYING OUT THE INVENTION

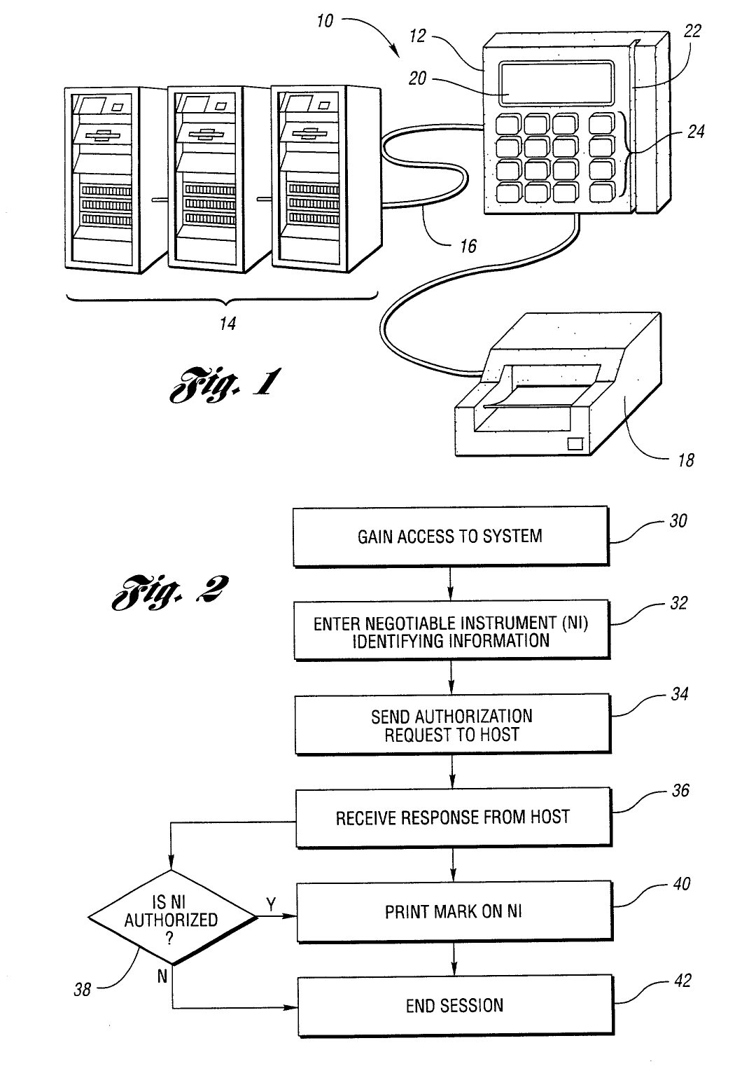

FIG. 1 shows a system 10 according to the present invention for processing a negotiable instrument, such as a money order, money transfer, gift certificate, coupon, traveler's check, payroll check, or other negotiable instrument, through a financial services firm, such as First Data Corporation. More specifically, the system 10 may be used to authorize such a negotiable instrument for encashment. System 10 includes a terminal 12 in communication with a host computer 14 via a communication network 16. Host computer 14 is typically a server computer or similar device. Communication network 16 may be any suitable network such as a local area network, a wide area network, a dial-up network, the Internet, a wireless network or any combination thereof. System 10 further includes a printer 18 in communication with the terminal 12.

Terminal 12 is configured to send data over the communication network 16 to host computer 14, and includes a display screen 20, a negotiable instrument reader 22, and a keypad 24. Negotiable instrument reader 22 may be an optical reader, a magnetic ink reader, a bar code reader, or image scanner as known in the art, and is used to quickly and efficiently input data contained on negotiable instruments into terminal 12. Alternatively, a user may input information into terminal 12 via the keypad 24, or audibly such as through a voice recognition unit (not shown). While terminal 12 may be any suitable terminal, terminal 12 is preferably an FDX-400® money order (MO) transaction machine available through First Data Corporation of Englewood, Colo.

Host computer 14 is used to determine the authorization status of negotiable instruments. Host computer 14 is configured to receive data from terminal 12 and to transmit data to terminal 12, for display on screen 20, and/or so that such data may be printed on negotiable instruments, or other documents, as explained below in greater detail. Generally, the financial services firm owns the host computer 14 and the terminal 12, as well as other terminals that are in communication with the host computer 14. Such other terminals may also be dispersed over a large area (e.g., nationwide).

Printer 18 is configured to receive negotiable instruments, and to automatically print a mark on each negotiable instrument that is indicative of the authorization status of the respective negotiable instrument. For example, the mark may be a number, an alpha-numeric sign, a message, a bar code, a symbol, or other image. Alternatively or supplementally, the printer 18 may be used to print such a mark on another document, such as a receipt associated with a particular negotiable instrument, or a transaction report associated with a particular encashing institution.

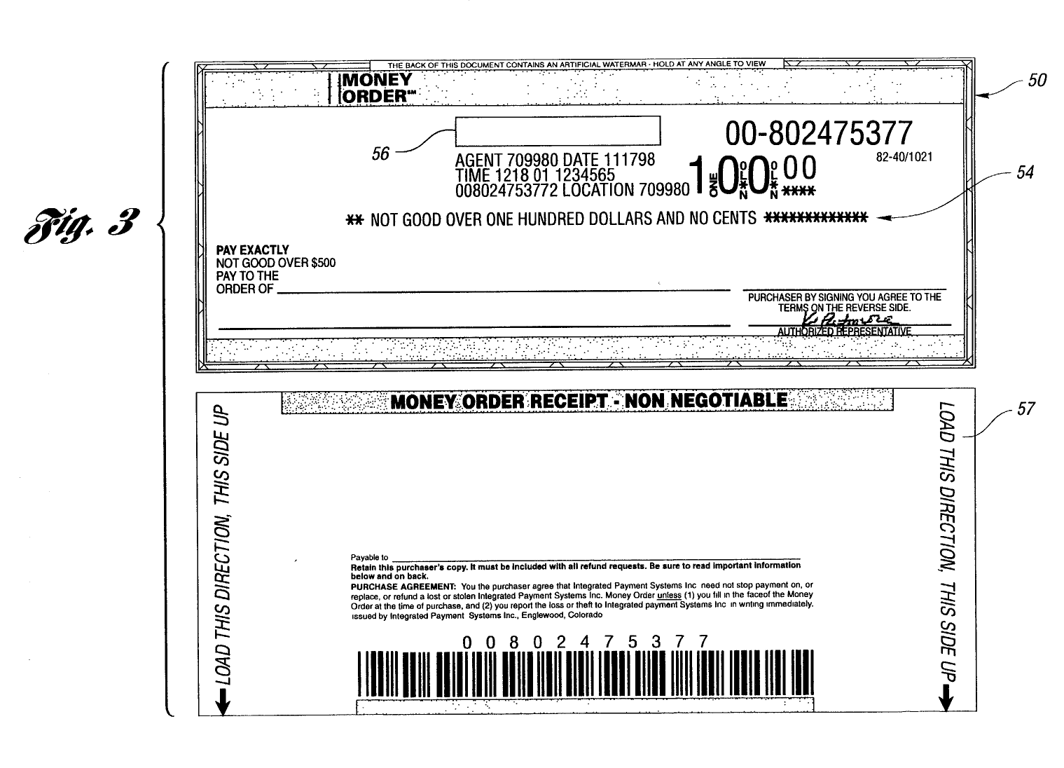

Referring now to FIGS. 1 and 2, an overview of a method according to the invention for processing a negotiable will now be described. When a customer enters an encashing institution to cash a negotiable instrument, an employee or agent of the encashing institution first gains access to system 10, as represented by block 30 of FIG. 2. At block 32, negotiable instrument identifying information is entered into terminal 12. For example, the negotiable instrument reader 22 may be used to read a serial number, a value, or other unique negotiable instrument identifier from the negotiable instrument. As another example, identifying information may be entered into terminal 12 using keypad 24. Terminal 12 then transmits the identifying information via the communication network 16 to host computer 14 so as to request authorization, as represented by block 34.

Next, the host computer 14 performs a comparison of the identifying information with a sales file, located on a database of the host computer 14, to determine whether there is a match. The sales file is a record of all sales transactions that have occurred using terminal 12, or by any other means. The sales file may also include transactions that have occurred at one or more locations.

At block 36, the terminal 12 receives a response from host computer 14 indicating authorization status of the negotiable instrument. If the identifying information matches the information contained in the sales file, then the negotiable instrument is authorized for encashment and an authorization sign is returned to the agent via terminal 12. The authorization sign may be, for example, a number, an alpha-numeric sign, a message, a bar code, a symbol, or other image. Host computer 14 also stores the authorization status of the negotiable instrument, thereby precluding any subsequent authorization request for the same negotiable instrument for a predetermined amount of time.

An authorization mark corresponding to the authorization sign is then automatically printed on the negotiable instrument using the printer 18, as represented by blocks 38 and 40. The authorization mark may be the authorization sign and/or some other number, alpha-numeric sign, message, bar code, symbol, or image that is related to the authorization sign, or otherwise corresponds with the authorization sign. For example, the authorization mark may include the words “VALID INSTRUMENT” or “O.K. TO CASH”. Alternatively or supplementally, the printer 18 may be used to print the authorization mark on another document, such as a receipt or transaction report. Next, the negotiable instrument may be cashed so as to complete the transaction and end the session, as represented by block 42.

If the identifying information does not match the information contained in the sales file, then a decline authorization message or sign is returned to terminal 12 and the session is ended, as represented by blocks 38 and 42. Such a decline authorization sign may be, for example, a number, an alpha-numeric sign, a message, a bar code, a symbol, or other image. Next, a decline authorization mark corresponding to the decline authorization sign may be automatically printed on the negotiable instrument and/or other document so as to indicate that the negotiable instrument is not authorized for encashment. The decline authorization mark may be the decline authorization sign and/or some other number, alpha-numeric sign, message, bar code, symbol, or image that is related to the decline authorization sign, or otherwise corresponds with the decline authorization sign. For example, the printer 18 may automatically print “VOID” on the negotiable instrument.

If the negotiable instrument is not authorized for encashment, the printer 18 may also be used to automatically print processing instructions or action steps on the negotiable instrument or other document. For example, the printer 18 may automatically print “POSSIBLE COUNTERFEIT INSTRUMENT, CALL CUSTOMER SERVICE.”

The present invention has many advantages over the prior art. First, because a mark indicative of authorization status is automatically printed on each negotiable instrument, or other related document, accuracy and reliability are significantly improved. Second, the mark may be configured as a bar code, or other suitable mark, that may be easily scanned by a scanning device, thereby facilitating reimbursement of funds to the encashing institution. Furthermore, under the method and system of the present invention, transaction efficiency is improved over the prior art.

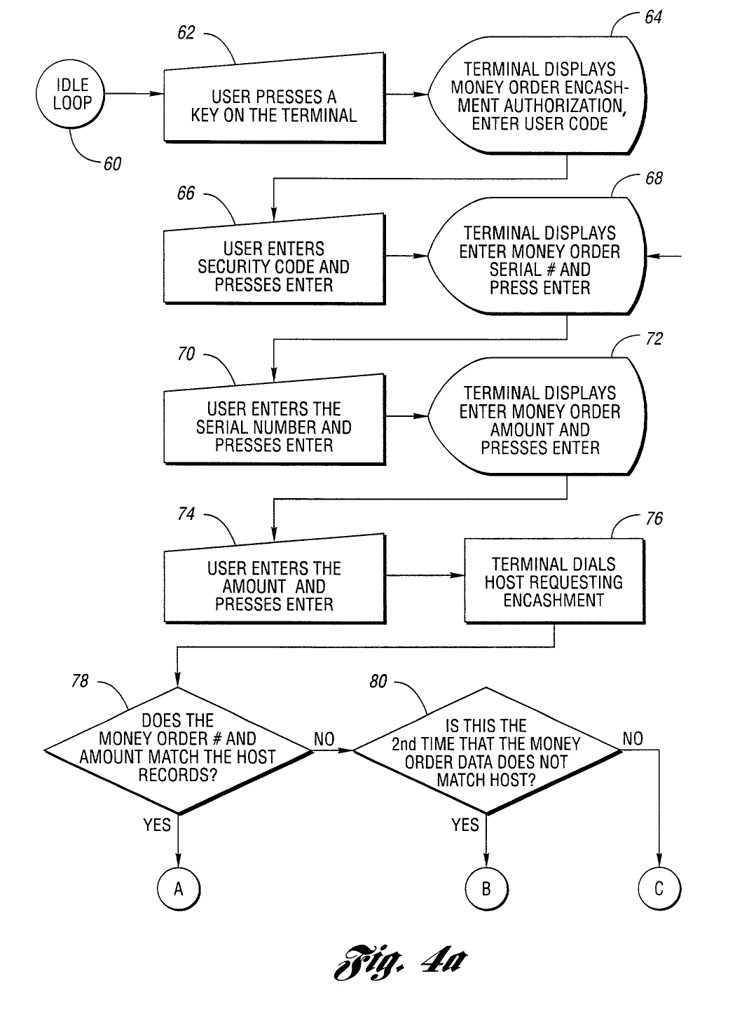

FIG. 3 shows an example of a negotiable instrument preprinted form 50, which may be used in connection with the present invention. The dollar amount of the negotiable instrument may be entered into section 54 by an agent. An authorization mark portion 56 is provided for receiving an authorization mark that indicates authorization status of the negotiable instrument, as determined by the financial services firm. The form 50 also includes a receipt portion 57, which may be provided to the customer.

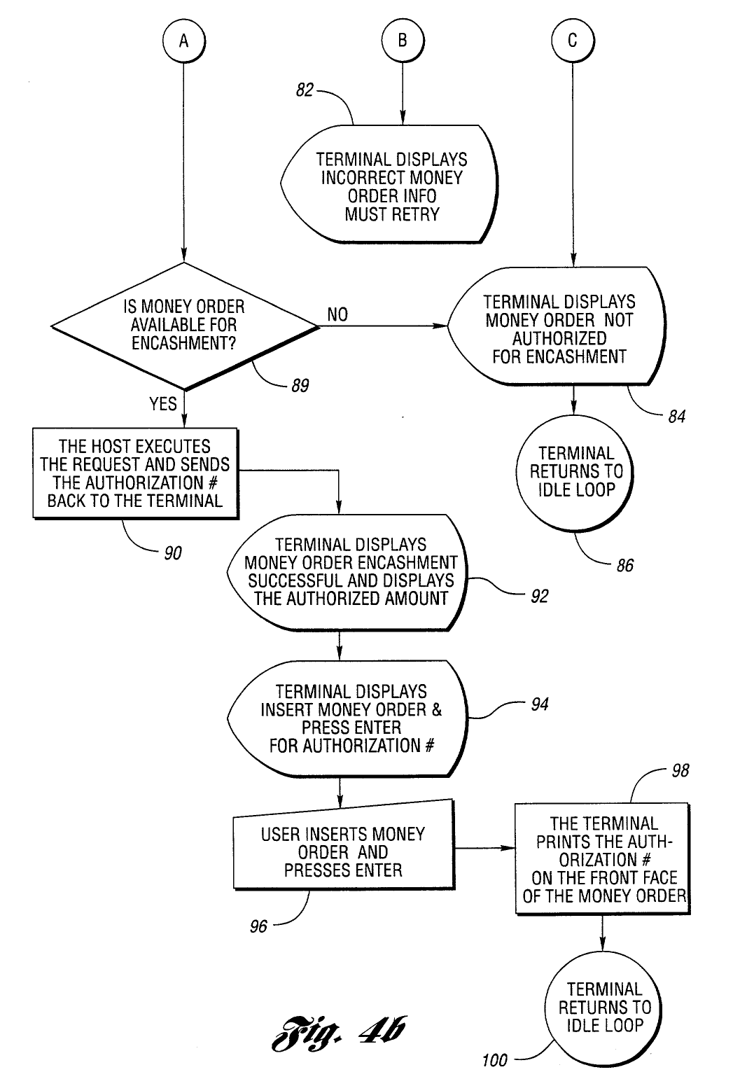

Referring now to FIG. 4 (4a and 4b), a detailed example for processing a negotiable instrument according to the invention will now be described. The following method is carried out on terminal 12 to obtain encashment authorization for a money order. Alternatively, the method may be applied to other negotiable instruments, such as money transfers, gift certificates, coupons, traveler's checks, or payroll checks.

When terminal 12 is turned on, terminal 12 resides in an idle loop, as indicated by block 60, until a user, such as an employee or agent of an encashing institution, manipulates the keypad 24. The user presses a key on the keypad 24 to initiate negotiable instrument authorization, as represented by block 62. At block 64, terminal 12 displays the message “MONEY ORDER ENCASHMENT AUTHORIZATION, ENTER USER CODE”, or a similar message. The user enters a security code and then presses ENTER on the terminal 12, as represented by block 66. Next, the terminal displays on screen 20 “ENTER MONEY ORDER SERIAL NUMBER AND PRESS ENTER” or similar message, as represented by block 68. At block 70, the user enters the serial number of the money order, which may be referred to as the money order number, and presses ENTER. The terminal 12 then displays “ENTER MONEY ORDER AMOUNT AND PRESS ENTER” or similar message, as represented by block 72. At block 74, the user enters the amount of the money order and presses ENTER. Other identifying information may also be input, such as money order date, time of issuance, issuing location, etc. At block 76, terminal 12 communicates with host computer 14, and requests an authorization sign, such as an authorization number, that is indicative of the authorization status of the negotiable instrument.

At block 78, the host computer 14 determines whether the money order number and the amount of the money order match the records on the host computer 14. If the money order information does not match the records of the host computer 14, then the terminal 12 displays the message “INCORRECT MONEY ORDER INFORMATION MUST RETRY”, or similar message, as represented by blocks 80 and 82. If the money order information does not match the records of the host computer 14 after a second attempt, or some other predetermined later attempt, then the terminal displays “MONEY ORDER NOT AUTHORIZED FOR ENCASHMENT”, or similar message, as represented by blocks 80 and 84. The transaction is then terminated and the terminal returns the idle loop, as represented by block 86. The printer 18 may also be used to automatically print a number or other sign on the money order so as to indicate that the money order is not authorized for encashment. For example, the printer 18 may automatically print “VOID” on the negotiable instrument.

If the money order number and amount match the records of the host computer 14, then the money order is checked for availability for encashment as represented by blocks 78 and 89. If the money order is available for encashment, the host computer 14 executes the request and sends an authorization number, or other authorization sign, back to terminal 12, as indicated at block 90. At block 92, the terminal 12 displays “MONEY ORDER ENCASHMENT SUCCESSFUL” and displays the authorized amount. At block 94, the terminal 12 then displays “INSERT MONEY ORDER AND PRESS ENTER FOR AUTHORIZATION NUMBER”. Next, the user inserts the money order face up in printer 18 and presses ENTER, as indicated at block 96. Printer 18 then automatically prints the authorization number or other authorization sign on the money order, as represented by block 98. Terminal 12 then returns to the idle loop, as represented by block 100. The negotiable instrument may then be cashed or otherwise converted to another negotiable instrument.

If the money order information contained in the sales file of the host computer 14 indicates that the money order has been “flagged” as fraudulent or lost, then the host computer 14 sends a message to the terminal 12 indicating that the money order is not available or authorized for encashment, as represented by blocks 89 and 84. Again, the printer 18 may be used to automatically print a number or other sign on the money order so as to indicate that the money order is not authorized for encashment. For example, the printer 18 may automatically print “VOID” on the negotiable instrument.

While embodiments of the invention have been illustrated and described, it is not intended that these embodiments characterize and enumerate all possible forms of the invention. Rather, the words used in the specification are words of description rather than limitation, and it is understood that various changes may be made without departing from the spirit and scope of the invention.

What is claimed is:

1. A method for processing a negotiable instrument, the method comprising:
entering at least one negotiable instrument identifier into a terminal;
transmitting the at least one negotiable instrument identifier from the terminal to a host computer;
receiving, at the terminal, a sign from the host computer, wherein the sign indicates an authorization status of the negotiable instrument; and
automatically printing a mark on a document using a printer in communication with the terminal, wherein the mark corresponds with the sign so as to indicate the authorization status of the negotiable instrument.

2. The method of claim 1 wherein the step of automatically printing a mark on a document comprises automatically printing the sign on the document.

3. The method of claim 1 wherein the mark indicates that the negotiable instrument is authorized for encashment.

4. The method of claim 1 wherein the mark indicates that the negotiable instrument is not authorized for encashment.

5. The method of claim 1 wherein the s step of automatically printing a mark on a document comprises automatically printing the mark on the negotiable instrument.

6. The method of claim 1 wherein the step of automatically printing a mark on a document comprises automatically printing an authorization number on the document.

7. The method of claim 1 wherein the step of automatically printing a mark on a document comprises automatically printing a bar code on the document.

8. The method of claim 1 wherein the step of entering at least one negotiable instrument identifier comprises entering a serial number of the negotiable instrument.

9. The method of claim 1 wherein the step of entering at least one negotiable instrument identifier comprises entering an amount of the negotiable instrument.

10. The method of claim 1 wherein the negotiable instrument is a money order.

11. The method of claim 1 wherein the negotiable instrument is a gift certificate.

12. A method for authorizing a negotiable instrument for encashment, the method comprising:
entering at least one negotiable instrument identifier into a terminal;
transmitting the at least one negotiable instrument identifier from the terminal to a host computer;
receiving, at the terminal, a sign from the host computer, wherein the sign indicates an authorization status of the negotiable instrument;
automatically printing the sign on the negotiable instrument using a printer in communication with the terminal; and
automatically printing processing instructions on the negotiable instrument if the sign indicates that the negotiable instrument is not authorized for encashment.

13. A system for processing a negotiable instrument, the system comprising
a terminal for receiving at least one negotiable instrument identifier;
a host computer in communication with the terminal for receiving the at least one identifier from the terminal and for determining an authorization status of the negotiable instrument, the host computer further being operative to issue a sign to the terminal that is indicative of the authorization status of the negotiable instrument; and
a printing device in communication with the terminal for automatically printing a mark on a document, wherein the mark corresponds with the sign so as to indicate the authorization status of the negotiable instrument.

14. The system of claim 13 wherein the printing device is operative to print the sign on the document.

15. The system of claim 13 wherein the printing device is operative to print the mark on the negotiable instrument.

16. The system of claim 13 wherein the terminal further comprises an optical reader for reading the at least one negotiable instrument identifier from the negotiable instrument.

17. The system of claim 13 wherein the terminal further comprises a magnetic ink reader for reading the at least one negotiable instrument identifier from the negotiable instrument.

18. The system of claim 13 wherein the terminal further comprises an image scanner for scanning the negotiable instrument so as to obtain the at least one negotiable instrument identifier.

19. The system of claim 13 wherein the terminal further comprises a bar code reader for reading the at least one negotiable instrument identifier from the negotiable instrument.

20. A system for authorizing a negotiable instrument for encashment, the system comprising:
a terminal for receiving at least one negotiable instrument identifier;
a host computer in communication with the terminal for receiving the at least one identifier from the terminal and for determining an authorization status of the negotiable instrument, the host computer being operative to issue a sign to the terminal that is indicative of the authorization status of the negotiable instrument, the host computer further being operative to issue processing instructions to the terminal if the negotiable instrument is not authorized for encashment; and
a printing device in communication with the terminal for automatically printing the sign on the negotiable instrument, the printing device further being operative to automatically print the processing instructions on the negotiable instrument if the negotiable instrument is not authorized for encashment.
